(19) United States
(12) Patent Application Publication
(10) Pub. No.: US 2024/0296574 A1
(43) Pub. Date: Sep. 5, 2024

(54) INFORMATION PROCESSING APPARATUS, INFORMATION PROCESSING METHOD, AND RECORDING MEDIUM

(71) Applicant: SONY GROUP CORPORATION, TOKYO (JP)

(72) Inventor: KOHEI MIYAMOTO, TOKYO (JP)

(21) Appl. No.: 18/571,776

(22) PCT Filed: Feb. 28, 2022
(86) PCT No.: PCT/JP2022/008209

§ 371 Date: Dec. 19, 2023

(30) Foreign Application Priority Data
Jun. 28, 2021 (JP) 2021-106881

(51) Int. Cl. G06T 7/50; G06V 40/16

(52) U.S. Cl. CPC G06T 7/50; G06V 40/171; G06T 2200/24; G06T 2207/30201

(57) ABSTRACT

An information processing apparatus according to an embodiment of the present technology includes: a detection unit; and an estimation unit. The detection unit detects, on the basis of a front face image of a user, information regarding a hairline of the user. The estimation unit estimates, on the basis of the hairline information and a template relating to a head, an outline of a head of the user. As a result, it is possible to reduce the burden on the user. Further, more natural shape estimation than before is made possible, and no special equipment is required.

### TECHNICAL FIELD

The present technology relates to an information processing apparatus, an information processing method, and a recording medium that are applicable to image analysis and the like.

### BACKGROUND ART

Patent Literature 1 describes a three-dimensional head model creation system for creating a three-dimensional model of a head on the basis of an image of a head covered with a printed sheet on which a plurality of characters is displayed. In the three-dimensional head model creation system, the three-dimensional model of a head is created by performing spatial arithmetic processing on the head image in which the printed sheet is in close contact with the head (paragraphs [0022] to [0038] of the specification, FIG. 1, and the like of Patent Literature 1).

### CITATION LIST

### Patent Literature

Patent Literature 1: Japanese Patent Application Laid-open No. 2020-190060

### DISCLOSURE OF INVENTION

### Technical Problem

There is a need for a technology capable of reduce the burden on a user in estimating a specific part of the user.

In view of the circumstances as described above, it is an object of the present technology to provide an information processing apparatus, an information processing method, and a recording medium that are capable of reducing the burden on the user.

### Solution to Problem

In order to achieve the above-mentioned object, an information processing apparatus according to an embodiment of the present technology includes: a detection unit; and an estimation unit. The detection unit detects, on the basis of a front face image of a user, information regarding a hairline of the user. The estimation unit estimates, on the basis of the hairline information and a template relating to a head, an outline of a head of the user.

In this information processing apparatus, information regarding a hairline of a user is detected on the basis of a front face image of the user, and an outline of a head of the user is estimated on the basis of the hairline information and a template relating to a head. As a result, it is possible to reduce the burden on the user.

The template may include a template of the outline of the head. In this case, the estimation unit may adjust the template on the basis of a shape of the hairline of the user and estimate the outline of the head of the user.

The front face image may include a face of the user. In this case, the detection unit may detect, on the basis of feature information relating to the face of the user, an area of skin of the user.

The detection unit may detect the hairline information on the basis of an outline of the area of skin.

The information processing apparatus may further include a selection unit that selects the template on the basis of the feature information.

The feature information may include information regarding a feature point of the face of the user or parts of the face of the user. In this case, the selection unit may select the template on the basis of the feature point and a feature point in the template.

The information processing apparatus may further include a determination unit that determines whether or not the hairline information has been correctly detected.

The determination unit may determine, where the degree of change in the template adjusted by the estimation unit is within a predetermined threshold value, that the hairline information has been correctly detected.

The information processing apparatus may further include a part estimation unit that estimates a hair part of the user on the basis of a detection result of the determination unit.

The part estimation unit may estimate, where the hairline information has not been correctly detected, the hairline of the user or a root of hair of the user.

The information processing apparatus may further include a presentation unit that presents a user interface (UI) for taking the front face image satisfying an imaging condition to the user.

The imaging condition may include a condition for allowing the information regarding a hairline of the user to be detectable.

An information processing method according to an embodiment of the present technology includes: detecting, on the basis of a front face image of a user, information regarding a hairline of the user. On the basis of the hairline information and a template relating to a head, an outline of a head of the user is estimated.

A recording medium that describes a program according to an embodiment of the present technology causes a computer system to execute the following steps of: detecting, on the basis of a front face image of a user, information regarding a hairline of the user; and estimating, on the basis of the hairline information and a template relating to a head, an outline of a head of the user.

### BRIEF DESCRIPTION OF DRAWINGS

FIG. 1 is a diagram showing an overview of an information processing apparatus.

FIG. 2 is a block diagram showing a configuration of the information processing apparatus.

FIG. 3 is a flowchart for estimating an outline of a head.

FIG. 4 is a diagram showing an example of a UI to be presented to a user.

FIG. 5 is a schematic diagram showing Step 103 to Step 107.

FIG. 6 is a schematic diagram showing estimation of an outline of a head.

FIG. 7 is a diagram showing an example of detecting a root of hair.

FIG. 8 is a block diagram showing a hardware configuration example of the information processing apparatus.

### MODE (S) FOR CARRYING OUT THE INVENTION

Hereinafter, an embodiment according to the present technology will be described with reference to the drawings.

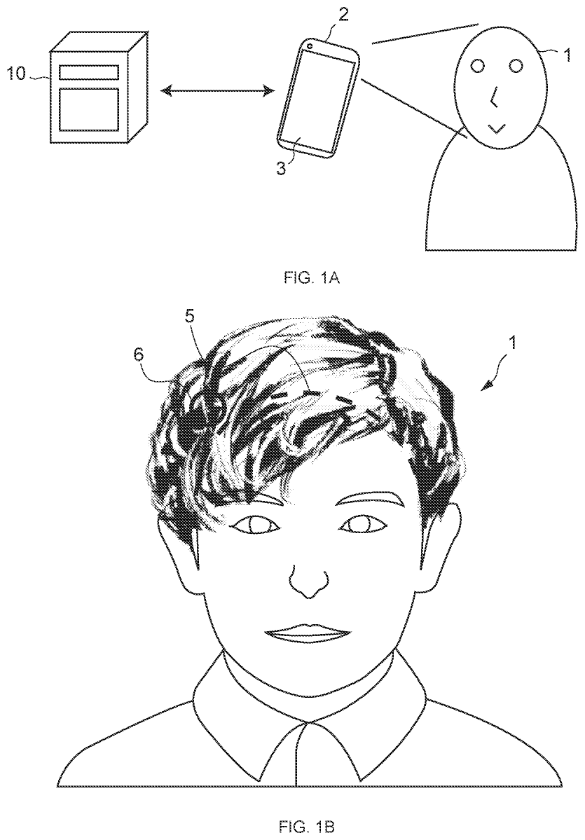

FIG. 1 is a diagram showing an overview of an information processing apparatus according to the present technology. Part A of FIG. 1 is a schematic diagram showing Example of the present technology.

As shown in Part A of FIG. 1, an information processing apparatus 10 acquires a front face image of a user 1 from an imaging apparatus 2 that images the user 1. In this embodiment, the imaging apparatus 2 includes a display device 3 such as a display and takes an RGB front face image of the user 1. Note that the imaging apparatus 2 is not limited and may be a mobile terminal such as a smartphone as shown in FIG. 1, a personal computer having an imaging function, or the like. Although an example in which the outline of the head of the user 1 is estimated from the front face image of the user 1 will be described in this embodiment, the outline of the head of the user 1 may be estimated from a plurality of front face images.

The information processing apparatus 10 detects information regarding a hairline of the user 1 on the basis of the taken front face image. The hairline information is information including the position and outline (shape) of the user's hairline. In this embodiment, the hairline refers to the boundary between areas where hair grows and areas where hair does not grow, of the user's forehead or nape.

Further, the information processing apparatus 10 estimates the outline of the user's head on the basis of the hairline information and a template relating to a head. The template relating to a head (hereinafter, referred to as a head template) is a template of various outlines of a head. Examples of the head template include various outlines of a head such as an oval shape and a long-face shape.

Part B of FIG. 1 is a schematic diagram showing a front face image of a user. As shown in Part B of FIG. 1, a hairline 5 (outline) is detected on the basis of a front face image of the user 1. Note that the hairline information is hidden by the user's bangs in some cases. Even in such a case, in the present invention, it is possible to detect the hairline information and estimate the outline of a head.

Further, as shown in Part B of FIG. 1, the information processing apparatus 10 estimates a root of hair 6 of the user 1. The root of hair refers to a part where hair is gathered.

Note that in this embodiment, the number of users 1 is not limited, and a plurality of users may be imaged.

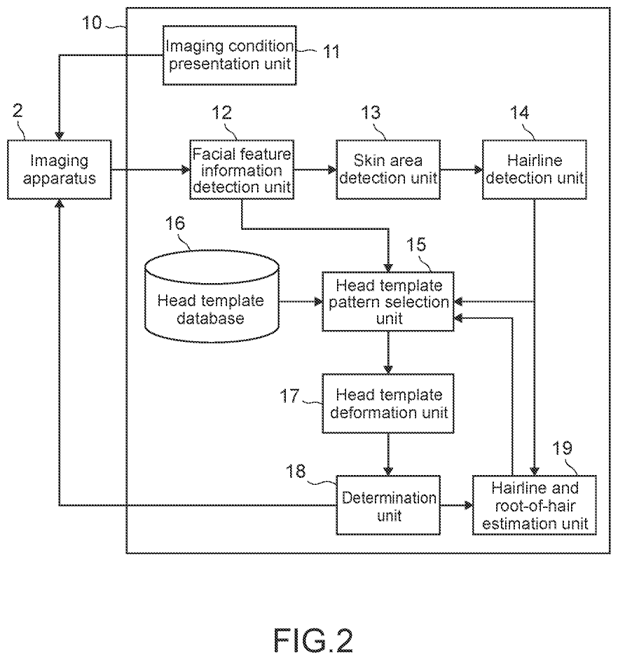

FIG. 2 is a block diagram showing a configuration of the information processing apparatus 10.

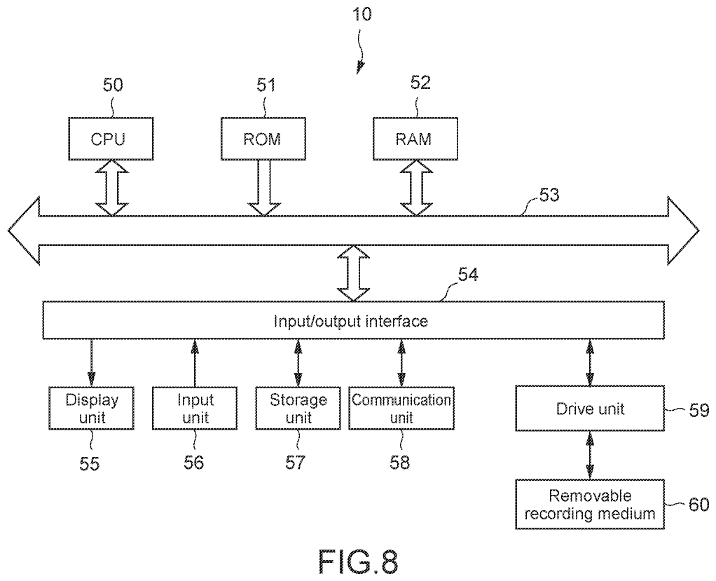

The information processing apparatus 10 includes hardware necessary for configuration a computer, e.g., a processor such as a CPU, a GPU, and a DSP, a memory such as a ROM and a RAM, a storage device such as an HDD (see FIG. 8). For example, the CPU loads the program according to the present technology stored in the ROM or the like in advance in the RAM and executes the program, thereby executing an information processing method according to the present technology. For example, it is possible to realize the information processing apparatus 10 by an arbitrary computer such as a PC. It goes without saying that hardware such as FPGA and ASIC may be used.

In this embodiment, when the CPU executes a predetermined program, a head template deformation unit as a functional block is configured. It goes without saying that in order to realize the functional blocks, dedicated hardware such as an IC (integrated circuit) may be used.

The program is installed in the information processing apparatus 10 via, for example, various recording media. Alternatively, the program may be installed via the Internet or the like. The type and the like of the recording medium on which the program is recorded are not limited, and an arbitrary computer-readable recording medium may be used. For example, an arbitrary computer-readable non-transitory storage medium may be used.

As shown in FIG. 2, the information processing apparatus 10 includes an imaging condition presentation unit 11, a facial feature information detection unit 12, a skin area detection unit 13, a hairline detection unit 14, a head template pattern selection unit 15, a head template database 16, a head template deformation unit 17, a determination unit 18, and a hairline and root-of-hair estimation unit 19.

The imaging condition presentation unit 11 presents an imaging condition for facilitating the detection of hairline information. For example, the imaging condition presentation unit 11 presents, to the user 1, whether or not various conditions are met, e.g., whether or not the face of the user 1 is facing the display device 3, whether or not the hairline of the user 1 is exposed, or whether or not to take an image while hair is not exposed.

In this embodiment, the imaging condition presentation unit 11 presents, to the imaging apparatus 2, a UI (User Interface) for recommending taking an image while the hairline of the user 1 is exposed.

The facial feature information detection unit 12 detects feature information relating to the user's face from the taken front face image. The feature information includes information regarding a facial feature point or facial parts (eyes, mouth, nose, or the like). Note that the method of detecting feature information is not limited, and machine learning or an arbitrary detection means may be used. In this embodiment, the detected feature information is supplied to the skin area detection unit 13 and the head template pattern selection unit 15.

The skin area detection unit 13 detects a skin area on the basis of the facial feature information. In this embodiment, the skin area detection unit 13 detects a skin patch estimated to be skin from the position of the facial feature point and detects a skin area on the basis of the average HSV value of the skin patch and edge information.

Note that the method of extracting edge information is not limited, and an arbitrary method such as Sobel, Canny, Prewitt, and Roberts may be used. The information of the detected skin area is supplied to the hairline detection unit 14.

The hairline detection unit 14 detects hairline on the basis of the detected skin area. In this embodiment, the hairline detection unit 14 sets, as the hairline information, the outline of the upper part of the skin area, i.e., the outline of the forehead and ears. Further, in this embodiment, the detected hairline information is supplied to the head template pattern selection unit 15 and the hairline and root-of-hair estimation unit 19.

The head template pattern selection unit 15 selects a suitable head template from the head template database 16 on the basis of the detected hairline information. In this embodiment, the head template is associated with the feature point of the lower part of the face, i.e., the outline of cheeks and jaw. The head template pattern selection unit 15 selects a suitable head template by checking the feature point of the outline of the face detected from the front face image against the feature point of the head template. The selected head template is supplied to the head template deformation unit 17.

Examples of the method of checking against the feature point of the head template stored in the head template database 16 include a method of matching three feature points of the upper right and left of ears and the lower jaw in the front face image and the head template and selecting the head template in which the total differences between the feature points of the lower part of the face other than these is the smallest. It goes without saying that the method of selecting the head template is not limited, and an arbitrary method may be used.

The head template deformation unit 17 performs deformation such as scaling, positional movement, and rotation of the selected head template. In this embodiment, the head template deformation unit 17 performs deformation in the X direction of the head template with reference to the feature points of the right and left ears. Further, the head template deformation unit 17 scales the head template on the basis of the hairline information and determines the enlargement rate in the Y direction.

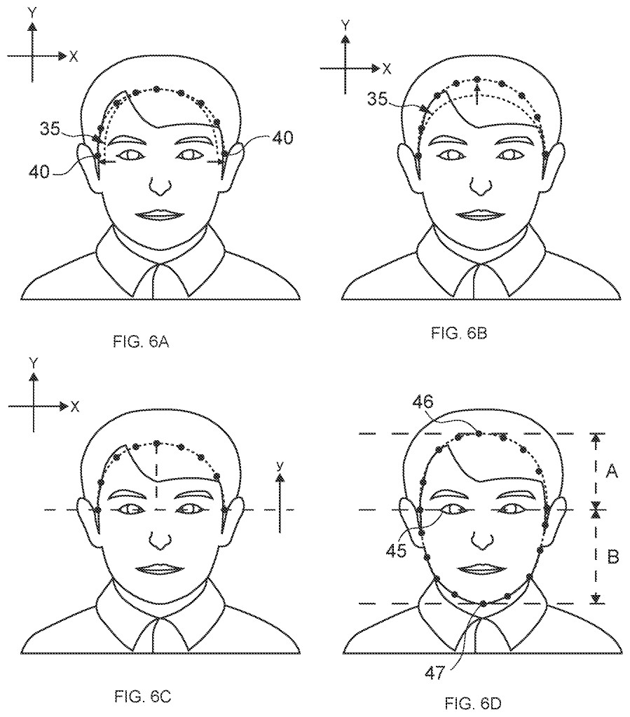

Note that the X direction in this embodiment is a direction that connects the right and left ears. The Y direction is a direction perpendicular to the X direction, and is, for example, a direction that connects the center position of both eyes and the lower jaw (see Part C of FIG. 6). Further, in this embodiment, the deformed head template is supplied to the determination unit 18.

The determination unit 18 determines whether or not the hairline information has been correctly detected. In this embodiment, the determination unit 18 determines, in the case where the degree of change in the deformed head template is within a predetermined threshold value, that the hairline information has been correctly detected.

For example, the determination unit 18 checks average face ratio information against the deformed head template, and determines, in the case where the uppermost part of the head template is not within a predetermined threshold value set in the average face ratio information, that the hairline information has not been correctly detected.

In this case, the head template deformation unit 17 determines the enlargement rate of the head template in the Y direction on the basis of the average face ratio information. Alternatively, the hairline and root-of-hair estimation unit 19 newly estimates hairline information and the enlargement rate in the Y direction is estimated again on the basis of the estimated hairline information.

The average face ratio information is information regarding parts of a person's average face. Examples thereof include position information and relative distance information of each part such as eyes, nose, and mouth, such as a distance between right and left eyes, a distance between an eye and an eyebrow, a ratio between the distance from the nose to the top of the head and the distance from the nose to the lower jaw, and a distance between nose and mouth.

The hairline and root-of-hair estimation unit 19 estimates a hairline and a root of hair. For example, the hairline and root-of-hair estimation unit 19 estimates a root of hair from the flow of the hair using Gabor-Filer or the like. The estimated hairline information is supplied to the head template pattern selection unit 15. The head template pattern selection unit 15 treats the estimated root of hair as a hidden hairline and selects a suitable head template.

Further, the hairline and root-of-hair estimation unit 19 acquires hairline information of the user 1 from the hairline detection unit 14 and estimates the root of hair for the part located above the hairline using the hairline information as auxiliary information.

Note that in this embodiment, the imaging condition presentation unit 11 corresponds to a presentation unit that presents a user interface (UI) for taking the front face image satisfying an imaging condition to the user. Note that this embodiment, the hairline detection unit 14 corresponds to a detection unit that detects, on the basis of a front face image of a user, information regarding a hairline of the user. Note that in this embodiment, the head template deformation unit 17 functions as an estimation unit that estimates, on the basis of the hairline information and a template relating to a head, an outline of a head of the user. Note that in this embodiment, the head template pattern selection unit 15 corresponds to a selection unit that selects the template on the basis of the feature information. Note that in this embodiment, the determination unit 18 corresponds to a determination unit that determines whether or not the hairline information has been correctly detected. Note that in this embodiment, the hairline and root-of-hair estimation unit 19 corresponds to a part estimation unit that estimates a hair part of the user on the basis of a detection result of the determination unit.

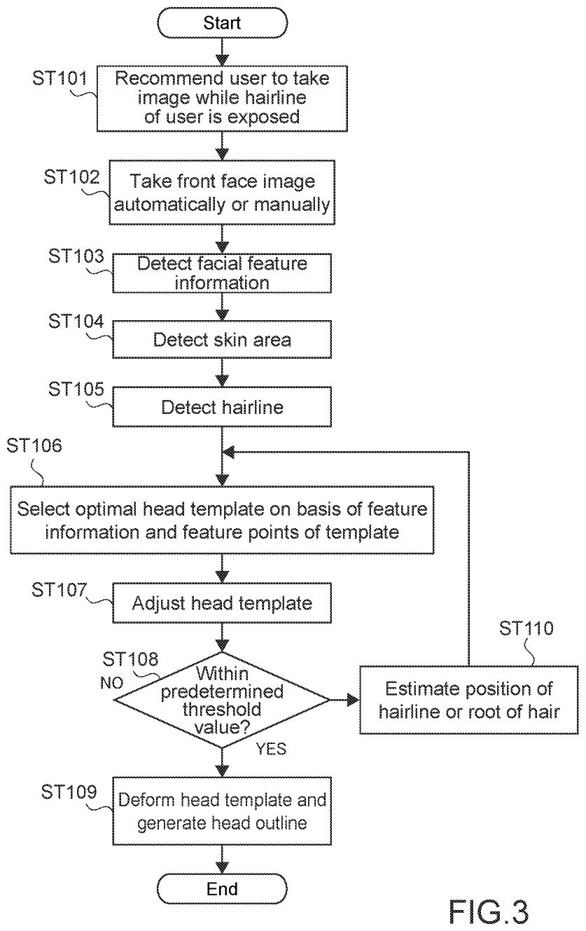

FIG. 3 is a flowchart for estimating an outline of a head.

As shown in FIG. 3, the imaging condition presentation unit 11 recommends a user to take an image while the hairline of the user is exposed (Step 101).

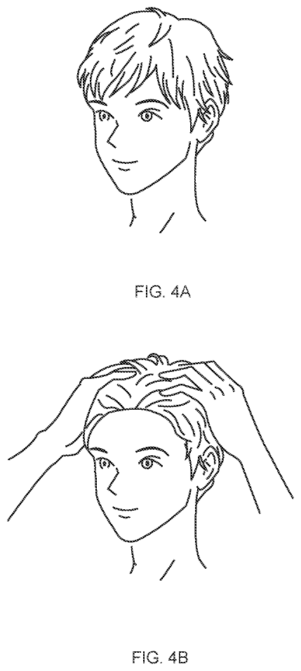

FIG. 4 is a diagram showing an example of a UI to be presented to a user.

For example, as shown in FIG. 4, the imaging condition presentation unit 11 presents, on the display device 3, a GUI (Graphical User Interface) for prompting a user whose hairline is not exposed (state in Part A of FIG. 4) to expose the hairline (state in Part B of FIG. 4).

In addition thereto, the imaging condition presentation unit 11 may present a voice, text message, or the like for prompting to expose hairline. Note that the presentation of a UI is only a recommendation because assumption is made that there is a case where it is difficult for the user to brush his/her hair, e.g., the hair is set with gel, spray, or the like, and the user can take an image without exposing the hairline.

Further, the imaging condition presentation unit 11 may present, in the case where an imaging condition has been met, e.g., the face of the user 1 is facing the imaging apparatus 2 or the hairline of the user 1 is exposed, a UI indicating that the imaging condition has been met.

The imaging apparatus 2 takes a front face image of the user (Step 102). For example, in the case where an image is automatically taken, the imaging apparatus 2 is prompted to automatically take an image when the hairline detection unit 14 detects that the user's hairline is exposed.

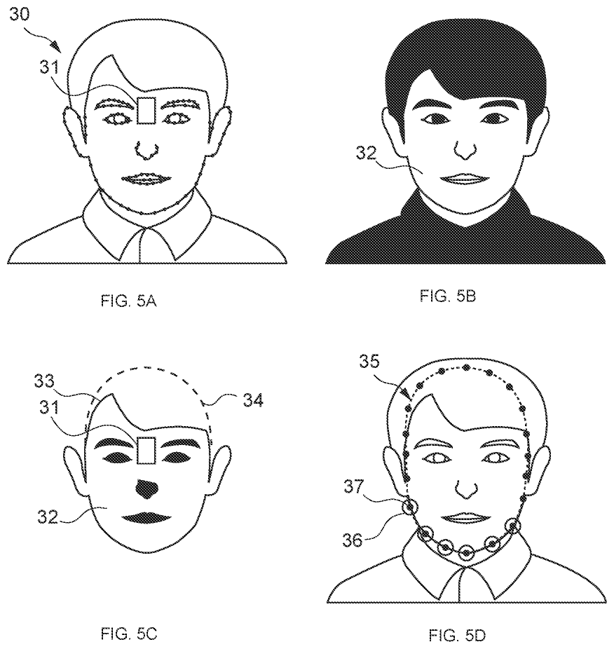

FIG. 5 is a schematic diagram showing Step 103 to Step 107. Part A of FIG. 5 is a diagram showing facial feature points. Part B of FIG. 5 is a diagram showing detection of a skin area. Part C of FIG. 5 is a diagram showing a skin area of a user. Part D of FIG. 5 is a diagram showing an example of the head template.

The facial feature information detection unit 12 detects feature information of a face 30 from a taken front face image (Step 103). In this embodiment, as shown in Part A of FIG. 5, the facial feature information detection unit 12 detects feature points of eyes, eyebrows, nose, ears, mouth, jaw, and the like.

The skin area detection unit 13 detects a skin area on the basis of the facial feature information (Step 104). In this embodiment, as shown in Part A of FIG. 5, a skin patch 31 is generated on the basis of the feature points of eyebrows and nose. Further, as shown in Parts B and C of FIG. 5, the skin area detection unit 13 detects, as a skin area 32, an area that includes the largest number of skin patch areas on the basis of the average HSV value of the generated skin patch and edge information.

The hairline detection unit 14 detects hairline on the basis of the detected skin area 32 (Step 105). As shown in Part C of FIG. 5, in this embodiment, the hairline detection unit 14 detects a hairline 34 from an outline 33 of the upper part of the skin area 32.

The head template pattern selection unit 15 selects a suitable head template 35 from the head template database 16 on the basis of the detected hairline 34 (Step 106). As shown in Part D of FIG. 5, in this embodiment, the head template pattern selection unit 15 selects the optimal head template by checking feature points 36 of the outline of the face against feature points 37 of the head template 35.

The head template deformation unit 17 deforms the head template (Step 107).

FIG. 6 is a schematic diagram showing estimation of an outline of a head. Part A of FIG. 6 is a diagram showing adjustment of the head template in the X direction. Part B of FIG. 6 is a diagram showing adjustment of the head template in the Y direction.

As shown in Part A of FIG. 6, the head template deformation unit 17 performs deformation in the X direction such as scaling, positional movement, and rotation of the selected head template 35 with reference to feature points 40 of the right and left ears. That is, the head template 35 is deformed such that the coordinates of the feature points located on the ears of the selected head template 35 match the feature points 40 of the user's ears.

As shown in Part B of FIG. 6, the head template deformation unit 17 performs deformation in the Y direction such as scaling, positional movement, and rotation of the head template 35 enlarged in the X direction. In this embodiment, the head template deformation unit 17 determines the enlargement rate of the head template in the Y direction on the basis of the hairline information. Note that the method of determining the enlargement rate in the Y direction assumes that the hairline information includes at least one pixel of hairline.

The determination unit 18 determines whether or not the deformed head template is within a predetermined threshold value set in the average face ratio information (Step 108). In the case where the deformed head template is within the predetermined threshold value (YES in Step 108), it is determined that the user's hairline has been correctly detected, and the outline of the deformed head template is generated as the outline of the user's head (Step 109).

In the case where the deformed head template is not within the predetermined threshold value (NO in Step 108), it is determined that the user's hairline has not been correctly detected. In this case, the hairline and root-of-hair estimation unit 19 estimates the user's hairline or root of hair (Step 110).

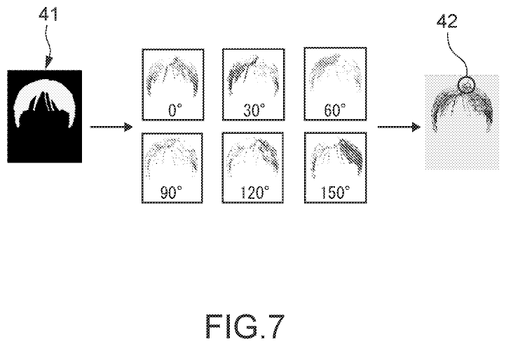

FIG. 7 is a diagram showing an example of detecting a root of hair.

In this embodiment, the hairline and root-of-hair estimation unit 19 estimates a root of hair from the flow of the hair using Gabor-Filer that uses a filter for extracting a specific frequency component for each direction.

For example, as shown in FIG. 7, a mask region 41 of a user is extracted from a front face image of the user, and filtering is applied to the filter region 41 in directions of 0 degrees, 30 degrees, 60 degrees, 90 degrees, 120 degrees, and 150 degrees. By combining the hair flows at the respective angles extracted by these filters, the part where the flows in various directions are aggregated is determined as a root of hair 42.

Further, the hairline and root-of-hair estimation unit 19 may estimate the user's hairline using a trained model trained from learning data in which feature points are placed on the hairline of an image including a face. For example, feature points may be placed at the positions estimated as the hairline by the hairline detection unit 14 to generate learning data.

The head template pattern selection unit 15 selects the optimal head template on the basis of the hairline or root of hair estimated by the hairline and root-of-hair estimation unit 19 (Step 106).

Further, in the case where the deformed head template is not within the predetermined threshold value (NO in Step 108), the head template deformation unit 17 may determine the enlargement rate in the Y direction on the basis of the average face ratio information. For example, as shown in Part D of FIG. 6, in the case where the ratio of a distance A from an eye 45 to a top 46 and a distance B from the 45 to a lower jaw 47 is 1:1 as the average face ratio information, the distance from the eye to the top (top of the hairline) is expanded such that the ratio of this distance and the distance from the eye to the lower jaw of the selected head template is 1:1.

As described above, in the information processing apparatus 10 according to this embodiment, hairline information of the user 1 is detected on the basis of a front face image of the user 1. The outline of the head of the user 1 is estimated on the basis of the hairline information and a template relating to a head. As a result, it is possible to reduce the burden on the user.

In the past, when generating a 3D model from a front face image, it has been difficult to correctly estimate the shape of the outline of a face, particularly, the outline of a head, because it is often hidden by hair. For example, a method of requiring a user to put an excessive burden such as wearing a dedicated cap is used. Alternatively, there is an example in which no estimation is performed, e.g., the outline of a head (shape) is fixed.

In the present technology, the user's hairline is detected on the basis of a front face image of the user, and the outline of the user's head is estimated by checking the hairline against a template relating to a head. Further, even in the case where the hairline is hidden, it is possible to estimate the outline of a head by simply asking the user to brush the hair back. As a result, more natural shape estimation than before is made possible, and no special equipment and no excessive burden on the user are required. Further, even in a situation in which the user cannot expose the hairline, it is possible to increase the robustness of estimating the outline of a head by estimating a hairline and a root of hair from average face ratio information or the like.

### Other Embodiments

The present technology is not limited to the embodiment described above, and various other embodiments may be implemented.

The outline of a head has been estimated from a front face image in the above embodiment. The present technology is not limited thereto, and the outline of a head may be estimated from a plurality of images including the user's head. For example, the imaging condition presentation unit 11 may present a UI for improving the estimation accuracy of the outline of a head.

The root of hair has been estimated from the hair flow and the outline of a head has been estimated in the above embodiment. In the case where it is difficult to estimate a root of hair, the outline of a head may be estimated with an average value on the basis of the ratio of the facial feature points.

FIG. 8 is a block diagram showing a hardware configuration example of the information processing apparatus 10.

The information processing apparatus 10 includes a CPU 50, a ROM 51, a RAM 52, an input/output interface 54, and a bus 53 that connects them to each other. A display unit 55, an input unit 56, a storage unit 57, a communication unit 58, a drive unit 59, and the like are connected to the input/output interface 54.

The display unit 55 is, for example, a display device using liquid crystal, EL, or the like. The input unit 56 is, for example, a keyboard, a pointing device, a touch panel, or another operation device. In the case where the input unit 56 includes a touch panel, the touch panel can be integrated with the display unit 55.

The storage unit 57 is a non-volatile storage device and is, for example, an HDD, a flash memory, or another solid-state memory. The drive unit 59 is, for example, a device capable of driving a removable recording medium 60 such as an optical recording medium and a magnetic recording tape.

The communication unit 58 is a modem, a router, or another communication device for communicating with another device, which can be connected to a LAN, a WAN, or the like. The communication unit 58 may perform wired or wireless communication. The communication unit 58 is often used separately from the information processing apparatus 10. In this embodiment, the communication unit 58 enables communication with another device via a network.

The information processing by the information processing apparatus 10 having the above hardware configuration is realized by cooperation of software stored in the storage unit 57, the ROM 51, or the like and hardware resources of the information processing apparatus 10. Specifically, the control method according to the present technology is realized by loading the program that is stored in the ROM 51 and constitutes software into the RAM 52 and executing the program.

The program is installed in the information processing apparatus 10 via, for example, the recording medium 60. Alternatively, the program may be installed in the information processing apparatus 10 via a global network or the like. In addition, an arbitrary computer-readable non-transitory recording medium may be used.

The information processing method and recording medium according to the present technology may be executed and the signal processing unit according to the present technology may be constructed by linking a computer installed in a communication terminal and another computer capable of communicating therewith via a network or the like.

That is, the information processing apparatus, information processing method, and recording medium according to the present technology can be executed not only in a computer system including a single computer but also in a computer system in which a plurality of computers operates in conjunction. Note that, in the present disclosure, the system refers to a set of components (such as apparatuses and modules (parts)) and it does not matter whether all of the components are in a single casing. Thus, both a plurality of apparatuses accommodated in separate casings and connected to each other through a network and a single apparatus in which a plurality of modules is accommodated in a single casing correspond to the system.

Execution of the information processing apparatus, information processing method, and recording medium according to the present technology by a computer system includes both a case where detection of a skin area, detection of a hairline, deformation of a head template, and the like are executed by a single computer and a case where each process is executed by different computers. Further, execution of each type of processing by a predetermined computer includes causing another computer to execute part or all of the processing and acquiring the result thereof.

That is, the information processing apparatus, information processing method, and recording medium according to the present technology can be applied to the configuration of cloud computing in which one function is shared and jointly processed by a plurality of devices via a network.

The configurations of the facial feature information detection unit, the hairline detection unit, the head template deformation unit, and the like, the control flow of the communication system, and the like described with reference to the drawings are merely an embodiment, and arbitrary modification can be made without departing from the essence of the present technology. That is, other arbitrary configurations and other arbitrary algorithms for implementing the present technology may be adopted.

Note that the effects described in the present disclosure are merely illustrative and not restrictive, and other effects may be obtained. The description of the plurality of effects described above does not necessarily mean that these effects are exhibited simultaneously. It means that at least one of the effects described above can be achieved in accordance with the condition or the like, and it goes without saying that there is a possibility that an effect that is not described in the present disclosure is exhibited.

Of the characteristic portions of each embodiment described above, at least two characteristic portions can be combined with each other. That is, the various characteristic portions described in the respective embodiments may be arbitrarily combined with each other without distinguishing from each other in the respective embodiments.

It should be noted that the present technology may also take the following configurations.

(1) An information processing apparatus, including:
a detection unit that detects, on the basis of a front face image of a user, information regarding a hairline of the user; and
an estimation unit that estimates, on the basis of the hairline information and a template relating to a head, an outline of a head of the user.
   (2) The information processing apparatus according to (1), in which
the template includes a template of the outline of the head, and
the estimation unit adjusts the template on the basis of a shape of the hairline of the user and estimates the outline of the head of the user.
   (3) The information processing apparatus according to (2), in which
the front face image includes a face of the user, and
the detection unit detects, on the basis of feature information relating to the face of the user, an area of skin of the user.
   (4) The information processing apparatus according to (3), in which
the detection unit detects the hairline information on the basis of an outline of the area of skin.
   (5) The information processing apparatus according to (3), further including
a selection unit that selects the template on the basis of the feature information.
   (6) The information processing apparatus according to (5), in which
the feature information includes information regarding a feature point of the face of the user or parts of the face of the user, and
the selection unit selects the template on the basis of the feature point and a feature point in the template.
   (7) The information processing apparatus according to (2), further including
a determination unit that determines whether or not the hairline information has been correctly detected.
   (8) The information processing apparatus according to (7), in which
the determination unit determines, where the degree of change in the template adjusted by the estimation unit is within a predetermined threshold value, that the hairline information has been correctly detected.
   (9) The information processing apparatus according to (8), further including
a part estimation unit that estimates a hair part of the user on the basis of a detection result of the determination unit.
   (10) The information processing apparatus according to (9), in which
the part estimation unit estimates, where the hairline information has not been correctly detected, the hairline of the user or a root of hair of the user.
   (11) The information processing apparatus according to (1), further including
a presentation unit that presents a user interface (UI) for taking the front face image satisfying an imaging condition to the user.
   (12) The information processing apparatus according to (11), in which
the imaging condition includes a condition for allowing the information regarding a hairline of the user to be detectable.
   (13) An information processing method for a computer system to execute the steps of:
detecting, on the basis of a front face image of a user, information regarding a hairline of the user; and
estimating, on the basis of the hairline information and a template relating to a head, an outline of a head of the user.
   (14) A recording medium that describes a program causing a computer system to execute the steps of:
detecting, on the basis of a front face image of a user, information regarding a hairline of the user; and
estimating, on the basis of the hairline information and a template relating to a head, an outline of a head of the user.

### REFERENCE SIGNS LIST

5 hairline
6 root of hair
10 information processing apparatus
11 imaging condition presentation unit
12 facial feature information detection unit
13 skin area detection unit
14 hairline detection unit
15 head template pattern selection unit
17 head template deformation unit
18 determination unit
19 hairline and root-of-hair estimation unit

1. An information processing apparatus, comprising:
a detection unit that detects, on a basis of a front face image of a user, information regarding a hairline of the user; and
an estimation unit that estimates, on a basis of the hairline information and a template relating to a head, an outline of a head of the user.

2. The information processing apparatus according to claim 1, wherein
the template includes a template of the outline of the head, and
the estimation unit adjusts the template on a basis of a shape of the hairline of the user and estimates the outline of the head of the user.

3. The information processing apparatus according to claim 2, wherein
the front face image includes a face of the user, and
the detection unit detects, on a basis of feature information relating to the face of the user, an area of skin of the user.

4. The information processing apparatus according to claim 3, wherein
the detection unit detects the hairline information on a basis of an outline of the area of skin.

5. The information processing apparatus according to claim 3, further comprising
a selection unit that selects the template on a basis of the feature information.

6. The information processing apparatus according to claim 5, wherein
the feature information includes information regarding a feature point of the face of the user or parts of the face of the user, and
the selection unit selects the template on a basis of the feature point and a feature point in the template.

7. The information processing apparatus according to claim 2, further comprising
a determination unit that determines whether or not the hairline information has been correctly detected.

8. The information processing apparatus according to claim 7, wherein
the determination unit determines, where the degree of change in the template adjusted by the estimation unit is within a predetermined threshold value, that the hairline information has been correctly detected.

9. The information processing apparatus according to claim 8, further comprising
a part estimation unit that estimates a hair part of the user on a basis of a detection result of the determination unit.

10. The information processing apparatus according to claim 9, wherein
the part estimation unit estimates, where the hairline information has not been correctly detected, the hairline of the user or a root of hair of the user.

11. The information processing apparatus according to claim 1, further comprising
a presentation unit that presents a user interface (UI) for taking the front face image satisfying an imaging condition to the user.

12. The information processing apparatus according to claim 11, wherein
the imaging condition includes a condition for allowing the information regarding a hairline of the user to be detectable.

13. An information processing method for a computer system to execute the steps of:
detecting, on a basis of a front face image of a user, information regarding a hairline of the user; and
estimating, on a basis of the hairline information and a template relating to a head, an outline of a head of the user.

14. A recording medium that describes a program causing a computer system to execute the steps of:
detecting, on a basis of a front face image of a user, information regarding a hairline of the user; and
estimating, on a basis of the hairline information and a template relating to a head, an outline of a head of the user.
